(19) United States
(12) Patent Application Publication
(10) Pub. No.: US 2012/0284764 A1
(43) Pub. Date: Nov. 8, 2012

(54) METHOD AND SYSTEM FOR REQUESTING SERVICES BY A MEDIA DEVICE

(76) Inventors: Keith Ball, San Jose, CA (US); Joseph Weber, Palo Alto, CA (US); Marvin Mednick, San Jose, CA (US)

(21) Appl. No.: 13/466,013

(22) Filed: May 7, 2012

Related U.S. Application Data
(60) Provisional application No. 61/610,980, filed on Mar. 14, 2012.
(60) Provisional application No. 61/483,040, filed on May 5, 2011.

(51) Int. Cl. H04N 21/643

(52) U.S. Cl. 725/110; 725/109

(57) ABSTRACT

A media device receives an Internet protocol (ip) address for an information routing device that is communicatively coupled with at least one server associated with at least one service. The media device sends to the information routing device over an Internet connection using the ip address, a request for one or more services from the at least one service. The media device receives the one or more services via one or more tuners.

### PRIORITY INFORMATION

The present invention claims priority under 35 U.S.C. 119(e) of provisional application No. 61/610,980 filed on Mar. 14, 2012 and also claims priority under 35 U.S.C. 119(e) of provisional application No. 61/483,040 filed on May 5, 2011.

### FIELD OF THE INVENTION

The present invention relates to a media device requesting services. More specifically the present invention relates to a media device requesting services over an Internet connection and receiving the services via a tuner.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Media devices such as a set top box or a digital video recorder receive one or more services that are subscribed to by a user of the media device. In an example, the user of a media device subscribes to a package of one or more “premium” multimedia channels (e.g., SHO, MAX, HBO, etc.). In another example, a user requests pay-per-view programming for a single program or a set of programs.

As a result of subscribing to the package of one or more multimedia channels, the user may receive the one or more services. An example of a service is a particular multimedia content stream that is received by a set-top box.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is a block diagram illustrating a system example in accordance with an embodiment;

FIG. 1B is a block diagram illustrating media device example in accordance with an embodiment;

FIG. 2 illustrates a flow diagram example for requesting and obtaining a service in accordance with one or more embodiments;

FIG. 3 is a block diagram illustrating an out-of-band system communication example in accordance with an embodiment; and

FIG. 4 shows a block diagram that illustrates a system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Several features are described hereafter that can each be used independently of one another or with any combination of the other features. However, any individual feature might not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in the specification.

Example features are described according to the following outline:
1.0 FUNCTIONAL OVERVIEW
2.0 SYSTEM ARCHITECTURE
3.0 EXAMPLE MEDIA DEVICE
4.0 REQUESTING AND OBTAINING A SERVICE
5.0 HARDWARE OVERVIEW
6.0 EXTENSIONS AND ALTERNATIVES

### 1.0 Functional Overview

One or more embodiments include methods for requesting services over an Internet connection and receiving the requested services in a radio frequency signal via a tuner. A service refers to data or information that is received by a media device. A service includes one or more multimedia programs and/or one or more continuous multimedia content streams that are received by a media device via a tuner. Examples of services include, but are not limited to, Video-On-Demand (VOD), Switch Digital Video (SDV), Pay-Per-View (PPV), and Caller Identification (Caller ID). In additional examples, a service includes a premium subscription channel such as HBO, a cable channel package, a particular movie that is streamable on demand, and a particular sporting event that is available on pay-per-view.

In an embodiment, a method includes a media device manager determining an Internet protocol (ip) address for an information routing device associated with a particular media device. The media device manager sends the ip address for the information routing device to the particular media device. The particular media device generates a request for one or more services and sends the request to the information routing device using the ip address received from the media device manager. The information routing device communicates information associated with the request to one or more servers which are associated with one or more services. Based on the information from the information routing device, the one or more servers transmit the one or more services to the particular media device. The particular media device receives the one or more services within a transmission signal via a tuner that is within the particular media device or via a tuner that is within another device separate from the particular media device.

### 2.0 System Architecture

Although a specific computer architecture is described herein, other embodiments of the invention are applicable to any architecture that can be used to perform the functions described herein.

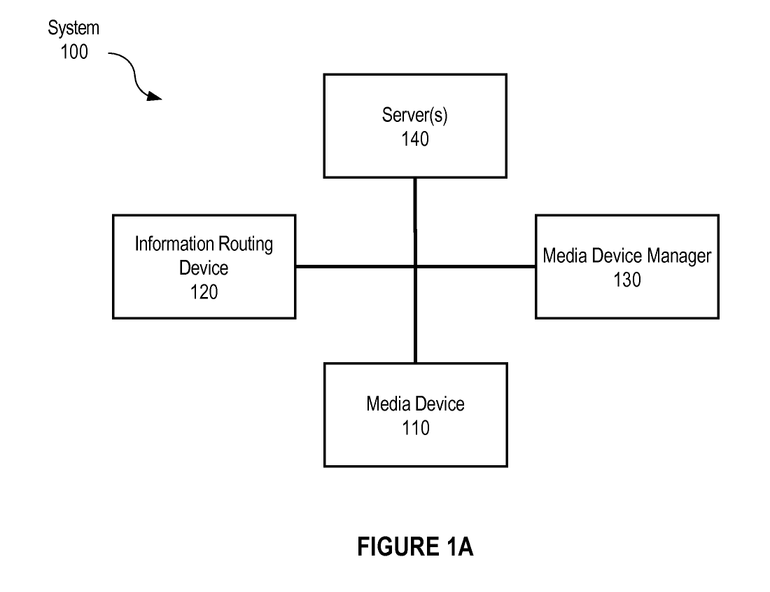

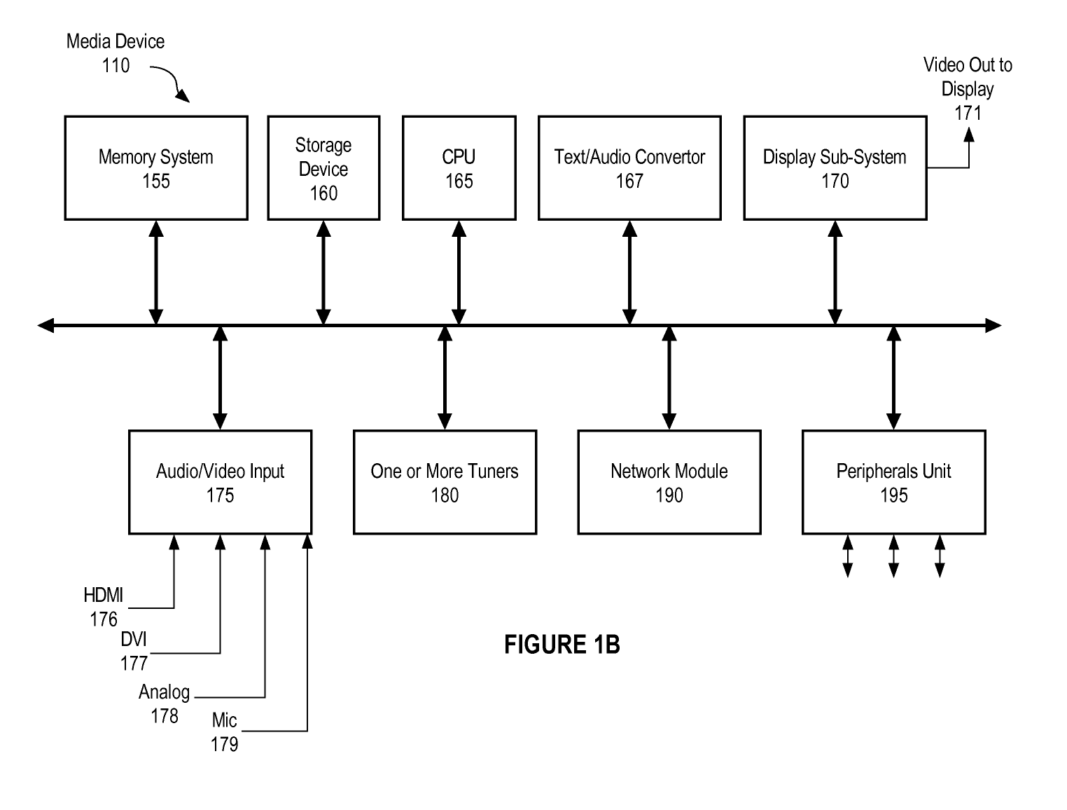

FIG. 1 shows an example system (100) which includes a media device (110), an information routing device (120), a media device manager (130), and one or more servers (140). Each of these devices are presented to clarify the functionalities described herein and may not be necessary to implement one or more embodiments. Furthermore, devices not shown in FIG. 1 may also be used to perform the functionalities described herein. Functionalities described as performed by one device may instead be performed by another device. Each of the devices described herein may be communicatively coupled with one or more of the other devices.

In an embodiment, the server (140) generally represents any content source from which the media device (110) can receive one or more services. In an example, the server (140) is a server from a set of servers that each provide at least one service. The server (140) uses local and/or remote memory storage to store data that is to be provided as a service. The server (140) may forward data in real time as the data is being received from a service provider. The server (140) may temporarily store data (for example, in a buffer, cache, other temporary storage, etc.). The server (140) may be implemented and/or controlled by a service provider, broadcaster, content provider, etc.

In an embodiment, the server (140) sends data within ip packets over an Internet connection. The data is converted by a converter (not shown) to a transmission signal (e.g., radio frequency, satellite downlink, cable transmission, etc.) that is sent to the media device (110).

In an embodiment, media device (110) generally represents any device that requests at least one service over an Internet connection and receives that requested service via a transmission signal. One or more individual components that may be included in the media device (110) are described below with reference to FIG. 1B.

In an embodiment, the media device (110) includes hardware to receive one or more services that are described above. In an example, the media device (110) includes one or more tuners (e.g., cablecard, analog tuner, digital tuner, satellite tuner, etc.) for receiving a transmission signal that includes one or more services. A tuner is further described below with reference to FIG. 1B.

In an embodiment, the media device (110) connects to a computer network via a network device that may be separate from the media device (110). In an example, the media device (110) is communicatively coupled, through wireless and/or wired segments, to a network device which sends and/or receives data for the media device (110).

The media device (110) is implemented as a single device or as a combination of multiple devices. In an example, the media device (110) includes a first device with a network card for sending a request for a service over an Internet connection and a second device for receiving a transmission signal which includes the service that was requested over the Internet connection.

In an embodiment, the media device (110) presents multimedia content by playing the multimedia content, displaying the multimedia content (e.g., still images, slideshows, video, etc.), printing the multimedia content (e.g., coupons, images, etc.), electronically transmitting the multimedia content (e.g., via electronic mail, IM, text, SMS, etc.), publishing the multimedia content (e.g., on a website, social network site, etc.), or by any other suitable means.

Examples of the media device (110) include one or more of: receivers, digital video recorders, digital video players, multimedia players, set-top boxes, Blu-ray players, audio content players, video content players, digital picture frames, tablets, touch pads, personal computers, e-readers, hand-held mobile devices, portable devices, etc.

In an embodiment, an information routing device (120) generally represents a device that processes a request, for one or more services, from the media device (110). The information routing device (120) includes a component that processes a request by forwarding the request or sending information associated with the request to a server that provides the requested services. In an example, the information routing device includes a parser for parsing a request to identify one or more requested services.

The information routing device (120) may be communicatively coupled with the media device (110) over an Internet connection. The information routing device (120) may be communicatively coupled with one or more servers (140) that provide one or more services to the media device (110).

In an embodiment, the information routing device (120) includes hardware that is used to connect to a computer network (for example, a local area network (LAN), Internet, intranet, world wide web, etc.) over a network connection. The information routing device (120) may include a network module to connect to a network. An example of a network module is described below, as a component of the media device (110), with relation to FIG. 1B.

The information routing device (120) is implemented as a single device or as a combination of multiple devices. In an example, the information routing device (120) is a proxy server which processes a request, for a caller ID service, from the media device (110) and sends information associated with the request to another server (140) which provides the requested caller ID service to the media device (110). In an example, the information routing device (120) is a data packet router which forwards the request received from a media device (110) to a server (140) which provides one or more services. In this example, the server (140) sends a message to the information routing device (120) (e.g., a caller ID, etc.). The information routing device (120) forwards the message to the media device manager (130), which then sends the message to the media device (110). In an embodiment, the information routing device (120) is a Virtual Private Network (VPN) server which receives a request from a media device (110) and sends information associated with the request to one or more servers (140) within a private network.

In an embodiment, the information routing device (120) and the server (140) are implemented together as a single device. In an example, the information routing device (120), that receives the request for a service from a media device (110) over an Internet connection, is the server (140) which provides the requested service to the media device (110).

In an embodiment, a media device manager (130) generally represents a device that provides configuration information to one or more media devices (for example, media device (110)). In an example, configuration information includes any information that is used by the media device (110) to request one or more services. The configuration information may include an Internet protocol address of a receiving device (for example, information routing device (120) or server (140)) to which a request for one or more services is to be sent.

In an embodiment, the media device manager (130) is communicatively coupled with the media device (110) over an Internet connection. In an embodiment, the media device manager (130) is communicatively coupled with a service operator (e.g., a multiple service operator (MSO), content provider, etc.) that provides information that is used by the media device manager (130) to configure the media device (110).

### 3.0 Example Media Device

FIG. 1B illustrates a block diagram of a media device example in accordance with one or more embodiments. As shown in FIG. 1B, the media device (110) may include multiple components such as a memory system (155), one or more storage devices (e.g., hard drive SSD, RAM, NVRAM, etc.) (160), a central processing unit (CPU) (165), a display sub-system (170), an audio/video input (175), one or more tuners (e.g., cablecard, analog tuner, digital tuner, satellite tuner, etc.) (180), a network module (190), peripherals unit (195), text/audio convertor (167), and/or other components necessary to perform the functionality described herein.

In an embodiment, the audio/video input (175) may correspond to any component that includes functionality to receive audio and/or video input (e.g., HDMI 176, DVI 177, Analog 178) from an external source. The media device (110) may include multiple audio/video inputs (175).

In an embodiment, the tuner (180) generally represents any input component that can receive a content stream over a transmission signal (e.g., through cable, satellite, terrestrial antenna, etc.). The tuner (180) may allow one or more received frequencies while filtering out others (e.g., by using electronic resonance). A television tuner may convert a radio frequency television transmission into audio and video signals which can be further processed to produce sound and/or an image.

In an embodiment, input and content may also be received from a network module (190). A network module (190) generally represents any input component that can receive information over a network (e.g., Internet, intranet, world wide web, etc.). Examples of a network module (190) include a network card, network adapter, network interface controller, network interface card, Local Area Network adapter, Ethernet network card, and/or any other component that can receive information over a network. The network module may be used to directly connect with another device (e.g., the information routing device (120) or the media device manager (130)).

In an embodiment, input may be received by the media device (110) from any communicatively coupled device through wired and/or wireless communication segments. Input received by the media device (110) may be stored to the memory system (155) or one or more storage devices (160). The memory system (155) may include one or more different types of physical memory to store data. For example, one or more memory buffers (e.g., an HD frame buffer) in the memory system (155) may include storage capacity to load one or more uncompressed high definition (HD) video frames for editing and/or fingerprinting. The memory system (155) may also store frames in a compressed form (e.g., MPEG2, MPEG4, or any other suitable format), where the frames are then uncompressed into the frame buffer for modification, replacement, and/or display. The memory system (155) may include FLASH memory, DRAM memory, EEPROM, traditional rotating disk drives, etc. The one or more storage devices (160) generally represents secondary storage accessible by the media device (110).

In an embodiment, central processing unit (165) may include functionality to perform the functions described herein using any input received by the media device (110). For example, the central processing unit (165) may be configured to generate a request for one or more services that have been subscribed to by a user or generate a request to subscribe to a new service. The central processing unit (165) may be used for processing communication with any of the input and/or output devices associated with the media device (110).

In an embodiment, the text/audio convertor (167) generally represents any software and/or hardware for converting text to audio and/or for converting audio to text. For example, the text/audio convertor may include functionality to convert text corresponding to closed captioned data to an audio file. The audio file may be based on a computerized voice, or may be trained for using the voice of a user, a fictional or non-fictional character, etc. In an example, the media device (110) may receive text which includes the caller ID of a person calling. The text/audio convertor (167) converts the caller ID to an audio file, stream, etc., which is then played by the media device (110).

In an embodiment, the peripherals unit (195) generally represents input and/or output for any peripherals that are communicatively coupled with the media device (110) (e.g., via USB, External Serial Advanced Technology Attachment (eSATA), Parallel ATA, Serial ATA, Bluetooth, infrared, etc.). Examples of peripherals may include remote control devices, USB drives, a keyboard, a mouse, a microphone, and voice recognition devices that can be used to operate the media device (110).

In an embodiment, the display sub-system (170) generally represents any software and/or device that includes functionality to output (e.g., Video Out to Display 171) and/or actually display one or more images. Examples of display devices include a kiosk, a hand held device, a computer screen, a monitor, a television, etc. The display devices may use different types of screens such as a liquid crystal display, cathode ray tube, a projector, a plasma screen, an LED screen, etc. The output from the media device (110) may be specially formatted for the type of display device being used, the size of the display device, resolution (e.g., 720i, 720p, 1080i, 1080p, or other suitable resolution), etc.

### 4.0 Requesting and Obtaining a Service

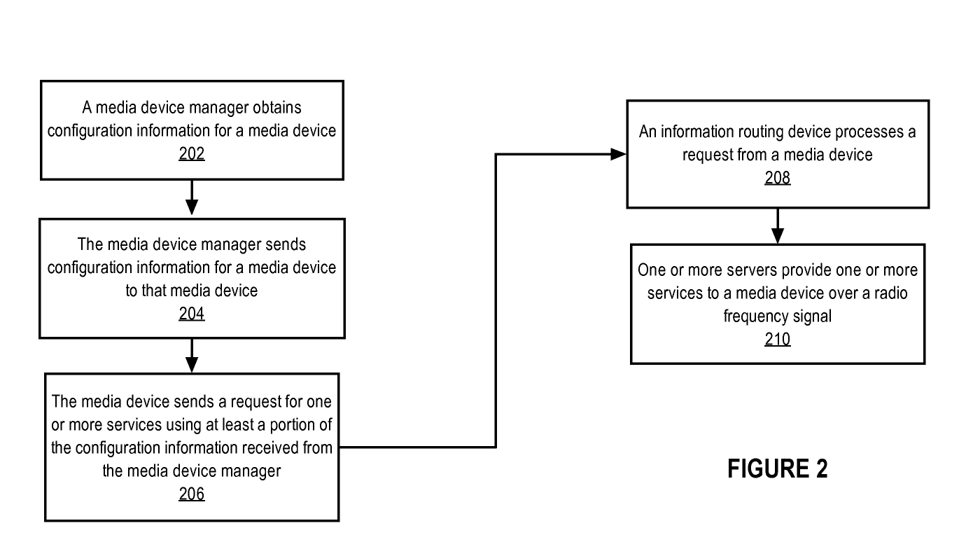

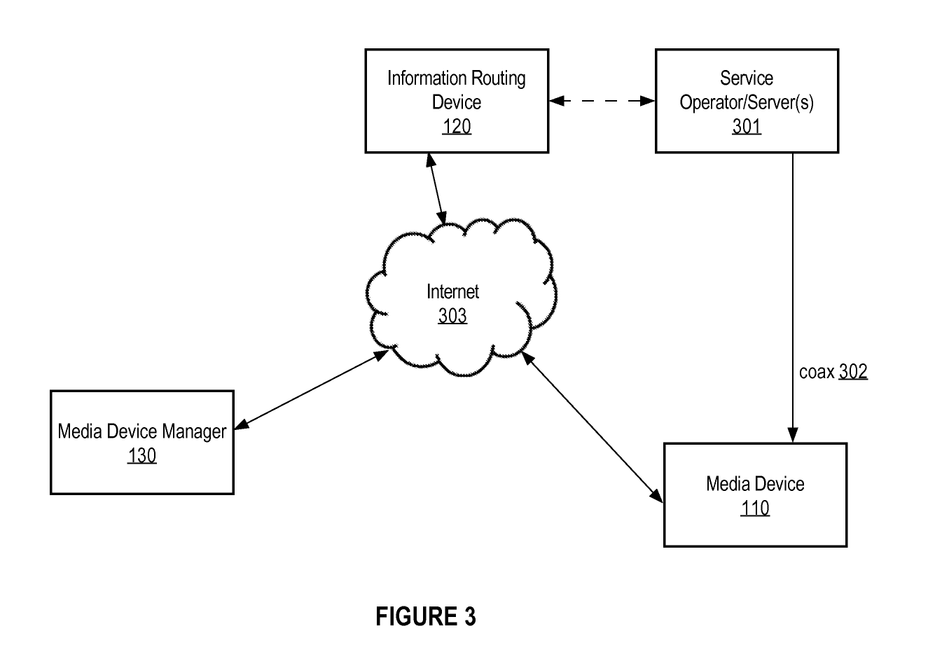

FIG. 2 illustrates a flow diagram for requesting and obtaining a service in accordance with one or more embodiments. One or more of the steps described below may be omitted, repeated, and/or performed in a different order. Accordingly, the specific arrangement of steps shown in FIG. 2 should not be construed as limiting the scope of the invention. FIG. 3 illustrates and out-of-band system communication example where a media device 110 receives services from service operator 301 via a one-way connection, e.g., a coaxial cable 302, where the services are received over the coaxial cable connection 302 by the media device 110 and the media device is unable to communicate directly to the service operator 301 via the coaxial cable connection 302.

Initially, a media device manager 130 obtains configuration information for a media device 110 (Step 202). The configuration information is collected from one or more sources and/or determined by the media device manager 130.

In an example, a service operator 301 (includes a multiple service operator) sends the media device manager 130, a list of the services that have been subscribed to by a user associated with a particular media device. The services that have been subscribed to include services that have been paid for before a service is provided or that are to be paid after a service is provided. In another example, the service operator 301 may provide activation codes for particular media devices or application programming interface information to be used by a media device when requesting a service. The media device manager 130 further receives, for a media device, the identification information of a corresponding information routing device to which that media device is to send requests for one or more services.

In an embodiment, the media device manager 130 receives device information for each information routing device of a set of one or more information routing devices. In an example, the device information for each information routing device is received from that information routing device. The device information for an information routing device includes an Internet protocol address for that information routing device and other identification information for that information routing device. The identification information for an information routing device may be used by a service operator to refer to the information routing device. In an example, the identification information may include a number (and/or letters) that has been assigned by a service operator. The Internet protocol address for an information routing device is stored in association with the identification information for that information routing device.

In an embodiment, the media device manager 130 receives from a service operator 301, for each customer of a set of customers, customer information associated with that customer. The customer information includes the identification information for an information routing device that is associated with that customer (for example, an information routing device that is to be used by the customer's media devices to request one or more services). The media device manager 130 determines an Internet protocol address for the information routing device, associated with the customer, using the device information for the information routing device. In an example, the media device manager queries the device information with the identification information for the information routing device that is associated with a customer. The query for the identification information for a particular information routing device returns the Internet protocol address for that particular information routing device. The Internet protocol address for the particular information routing device is stored in association with one or more customers that are associated with that particular information routing device.

In an embodiment, the media device manager 130 sends configuration information for a media device to that media device 110 (Step 204). The configuration information may be sent by the media device manager 130 for any of the following: sent in response to a request for the configuration information from the media device 110; pushed from the media device manager 130 to the media device 110; or sent to the media device 110 by the media device manager 130 in response to a request from a third party. In an example, the media device manager 130 sends, to a media device 110, an Internet protocol address of an information routing device 120 so that the media device 110 can send service requests to that information routing device 120. In an example, the media device manager 130 sends, to a media device 110, a list of services that are subscribed to by a user associated with that media device. In an example, the media device manager 130 sends, to a media device 110, a list of multimedia content that has been licensed or purchased by a user associated with that media device. In an example, the media device manager 130 sends, to a media device 110, application programming interface information to access an information routing device 120.

In an embodiment, the media device manager 130 sends configuration information for a media device to that media device 110 in response to receiving a request for the configuration information. In an example, a media device 110 requests the Internet protocol address for sending a request for services and a list of services that are subscribed to by a user of the media device. In response, the media device manager 130 sends the Internet protocol address of an information routing device 120 and a list of services subscribed to by a user of the media device.

In an embodiment, a media device 110 sends a request for one or more services using at least a portion of the configuration information received from the media device manager 130 (Step 206). In an example, the media device 110 generates a request for all the services that a user, associated with that media device, has already subscribed to. In another example, the media device 110 generates a request to subscribe to one or more services selected by a user. The media device 110 includes within the request an Internet protocol address received from the media device manager 130 as the destination address for the request to be used by data packet routers forwarding the request. The media device sends the request via an Internet connection through a computer network (e.g., the world wide web, etc.).

In an example, a user of a set-top box selects a pay-per-view sporting event for viewing. The set top box generates a request for the pay-per-view sporting event that the set top box sends over an Internet connection to an ip address received from a media device manager. In another example, a digital video recorder determines based on the information received from the media device manager that a user associated with the digital video recorder has subscribed to HBO programming. The digital video recorder generates a request for an HBO multimedia content stream and sends the request directly to an information routing device which is also a server that streams the HBO multimedia content stream to the digital video recorder.

In an embodiment, an information routing device 120 processes a request from a media device 110 (Step 208). Processing a request may include denying, accepting, modifying, and/or forwarding the request received from a media device 110. In an example, the information routing device 120 denies a request for a service because a user, associated with the requesting media device, has not subscribed to that service. In another example, the information routing device 120 initiates a new subscription for a service based on a request for that service. Request processing rules, for denying, modifying, accepting and/or forwarding a request, that are implemented by an information routing device 120 may be controlled by an administrator or based on received commands. In an example, a request for pay-per-view programming that includes payment information, user account information, etc., that are used to charge a customer or customer's account, is accepted while a request for pay-per-view programming without payment information is denied. The information routing device 120 filters requests based on one or more criteria including but not limited to: authorization, permissions, payment, location of device(s), etc. In an embodiment, a forwarded request may be denied, accepted, or modified by another entity (for example, a server that provides services).

In an embodiment, the information routing device selects a server 301 from a set of servers to service the request received from the media device. The information routing device selects the server(s) based on the requested service(s). In an example, the information routing device 120 selects the server 301 for sending the information, associated with a requested service, based on a location of the server and/or a location of the media device requesting the service. In an example, the information routing device accesses a database which lists, for each media device, one or more associated servers that provide the services for that media device. The selected server may be one of a set of servers that are available and/or suitable for providing a service to a media device. In an example, the suitability of a server is based on one or more of: service provided, server bandwidth, server load, server processing power, server speed, server restrictions, media device restrictions, media device functionality, etc.

In an embodiment, the information routing device 120 sends information, associated with the requested service, to the selected server 301. Sending the information includes forwarding the request in its entirety, forwarding a portion of the request, or sending information that is determined based on the request to one or more selected servers.

In an embodiment, one or more servers provide one or more services to a media device 110 (Step 210). In an example, the services are delivered via a coaxial cable delivery mechanism 302. The servers may provide a one-time service, a periodic service, or a continuous service. For example, a server may distribute a recording of a particular program or may stream contents across a particular channel requested by a media device. In another example, a server may provide a caller ID service for a voice over IP phone. In this example, the server may send an identity of a caller to a digital video recorder each time a call is received. A digital video recorder, for example, can then display the identity of the caller, e.g., by over laying the identity of the caller on a television program that is being displayed, sending the identity of the caller to a remote control, cellular phone, wireless device, wired device, etc. In another example, a server may stream different basketball games that are included in a particular sports programming package that is subscribed to by a user. The services provided by a server may be sent as a live television stream where a media device displays a program as it is received. The services may be sent as content files where a media device may receive the content files and store the content files for a user to access the content files at a future time. The services may be sent from a server to a media device in response to a specific request. In an example, a first request from a set top box may subscribe a user to a collection of programs (e.g., programs included in HBO on demand, all SHO stations, etc.). Thereafter, additional requests from the set top box may be sent for each individual program in the collection of programs that a user wants to view. In another example, a request from a set top box may subscribe a user to a pay-per-view program or event.

In an embodiment, sending one or more services includes a server sending Internet protocol packets that are converted to a radio frequency signal which is transmitted to a media device. In another embodiment, sending one or more services includes a server transmitting a radio frequency signal to a media device. The transmitted data may include one or more codes needed by a tuner in the media device to access a service. In an example, a multimedia program may be sent to a media device via a satellite. In an embodiment, sending one or more services includes transmission of data over transmission media including one or more of: coaxial cables, copper wire, fiber optics, acoustic, light waves, wireless, RF frequency, microwave, etc.

In an embodiment, services requested by a media device through an information routing device do not traverse that information routing device when the services are being delivered to the media device from a server. In an example, a media device sends a request for a service, over a computer network, to an information routing device. The information routing device forwards, over a computer network, the request to a server. The server sends the service as one or more ip data packets or video signals which are converted by a convertor to a radio frequency or transmission signal. The convertor then sends the radio frequency signal to a media device through a coaxial cable connected to the media device. A tuner in the media device interprets the radio frequency signal to extract multimedia content for playback to a user.

### 5.0 Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

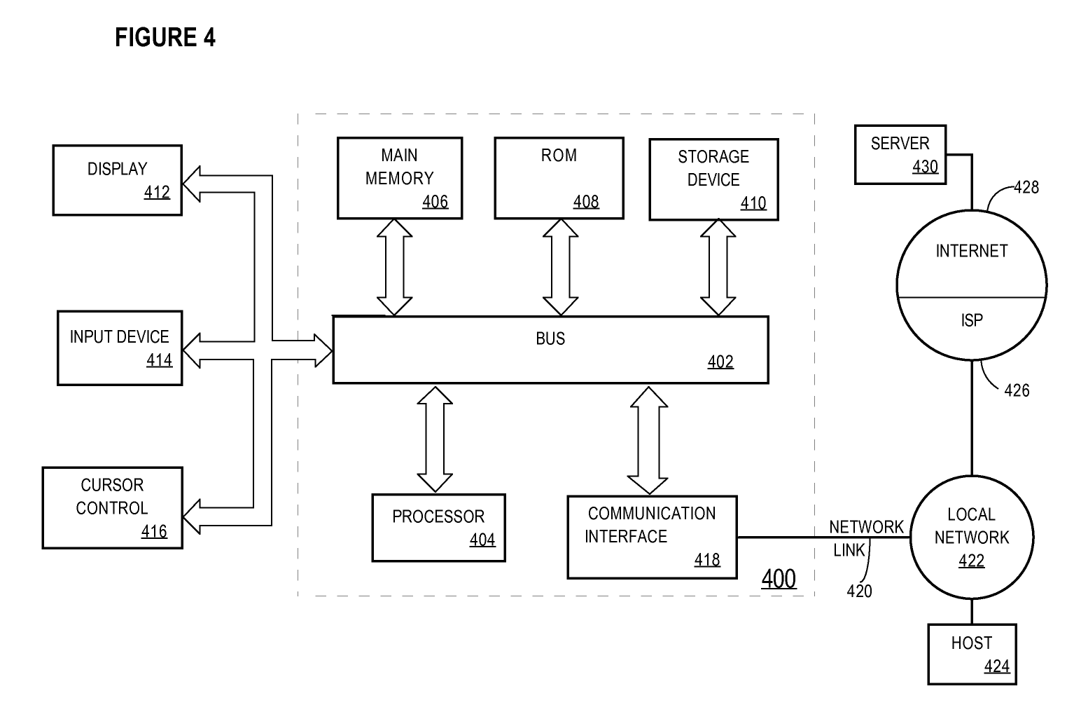

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 6.0 Extensions and Alternatives

Embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense. Any combination of the features, functionalities, components, and example embodiments described herein may be implemented.

1. A method, comprising:
receiving, by a media device, an Internet protocol (ip) address for an information routing device that is communicatively coupled with at least one server associated with at least one service,
sending, by the media device to the information routing device, over an Internet connection using the ip address, a request for one or more services from the at least one server;
receiving the one or more services by the media device via one or more tuners.

2. The method as recited in claim 1, wherein the one or more services are services that have been subscribed to, by a user associated with the media device, prior to the media device receiving the ip address.

3. The method as recited in claim 1, wherein the request, sent by the media device, for the one or more services is a request to subscribe to the one or more services based on user input received from a user associated with the media device.

4. The method as recited in claim 1, wherein the information routing device is a proxy server.

5. The method as recited in claim 1, wherein the information routing device is a data packet router.

6. The method as recited in claim 1, further comprising prior to receiving the configuration information: requesting, by the media device over the Internet connection, the configuration information from a media device manager.

7. The method as recited in claim 1, wherein the one or more services requested by the media device comprises one or more of: video on demand service, switch digital video service, caller identification service, or pay per view service.

8. The method as recited in claim 1, wherein the one or more services are received by the media device from the at least one server without the one or more services traversing the information routing device.

9. The method as recited in claim 1, wherein the one or more services are received by the media device via a coaxial cable or a satellite.

10. A non-transitory computer readable medium storing instructions which, when executed by one or more processors, cause performance of steps comprising:
receiving, by a media device, an Internet protocol (ip) address for an information routing device that is communicatively coupled with at least one server associated with at least one service,
sending, by the media device to the information routing device, over an Internet connection using the ip address, a request for one or more services from the at least one server;
receiving the one or more services by the media device via one or more tuners.

11. The non-transitory computer readable storage medium as recited in claim 10, wherein the one or more services are services that have been subscribed to, by a user associated with the media device, prior to the media device receiving the ip address.

12. The non-transitory computer readable storage medium as recited in claim 10, wherein the request, sent by the media device, for the one or more services is a request to subscribe to the one or more services based on user input received from a user associated with the media device.

13. The non-transitory computer readable storage medium as recited in claim 10, wherein the information routing device is a proxy server.

14. The non-transitory computer readable storage medium as recited in claim 10, wherein the information routing device is a data packet router.

15. The non-transitory computer readable storage medium as recited in claim 10, the steps further comprising prior to receiving the configuration information: requesting, by the media device over the Internet connection, the configuration information from a media device manager.

16. The non-transitory computer readable storage medium as recited in claim 10, wherein the one or more services requested by the media device comprises one or more of: video on demand service, switch digital video service, caller identification service, or pay per view service.

17. The non-transitory computer readable storage medium as recited in claim 10, wherein the one or more services are received by the media device from the at least one server without the one or more services traversing the information routing device.

18. The non-transitory computer readable storage medium as recited in claim 10, wherein the one or more services are received by the media device via a coaxial cable or a satellite.

19. An apparatus comprising:
a subsystem, implemented at least partially in hardware, at a media device, that receives an Internet protocol (ip) address for an information routing device that is communicatively coupled with at least one server associated with at least one service,
a subsystem, implemented at least partially in hardware, at a media device, that sends to the information routing device, over an Internet connection using the ip address, a request for one or more services from the at least one server;
a subsystem, implemented at least partially in hardware, at a media device, that receives the one or more services via one or more tuners.

20. The apparatus as recited in claim 19, wherein the one or more services are services that have been subscribed to, by a user associated with the media device, prior to the media device receiving the ip address.

21. The apparatus as recited in claim 19, wherein the request, sent by the media device, for the one or more services is a request to subscribe to the one or more services based on user input received from a user associated with the media device.

22. The apparatus as recited in claim 19, wherein the information routing device is a proxy server.

23. The apparatus as recited in claim 19, wherein the information routing device is a data packet router.

24. The apparatus as recited in claim 19, the steps further comprising prior to receiving the configuration information: requesting, by the media device over the Internet connection, the configuration information from a media device manager.

25. The apparatus as recited in claim 19, wherein the one or more services requested by the media device comprises one or more of: video on demand service, switch digital video service, caller identification service, or pay per view service.

26. The apparatus as recited in claim 19, wherein the one or more services are received by the media device from the at least one server without the one or more services traversing the information routing device.

27. The apparatus as recited in claim 19, wherein the one or more services are received by the media device via a coaxial cable or a satellite.

28. A system comprising:
a media device;
a media device manager;
wherein the media device manager is configured to:
for each information routing device of a plurality of information routing devices:
receive device information comprising an Internet protocol (ip) address for that information routing device and identification information for that information routing device;
for each customer of a plurality of customers:
receive identification information for an information routing device, of the plurality of information routing devices, that is associated with that customer;
determine an ip address for the information routing device based on device information for the information routing device;
send, over an Internet connection to a media device associated with that customer, the ip address for the information routing device;
wherein the media device is configured to:
receive the Internet protocol (ip) address for the information routing device;
send a request for one or more services to the information routing device over an Internet connection using the ip address;
receive the one or more services by the media device via one or more tuners.

29. The system of claim 28, wherein the information routing device is configured to send information associated with the request to one or more servers.

30. The system of claim 28, wherein the media device is one or more of: a set top box or a digital video recorder.

31. The system of claim 28, wherein the media device manager is configured to send the ip address for the particular information routing device responsive to receiving a request from the media device.

32. The system of claim 28, wherein the information routing device is a VPN server.

33. The system of claim 28, wherein the one or more services requested by the media device comprises one or more of: video on demand service, switch digital video service, caller identification service, or pay per view service.

34. The system of claim 28, wherein the media device manager is communicatively coupled with the information routing device and the media device over an Internet connection.

35. The system of claim 28, wherein the media device manager is configured to receive the device information from the plurality of information routing devices and the customer information from one or more service operators.
